(19) United States
(12) Patent Application Publication
(10) Pub. No.: US 2006/0257191 A1
(43) Pub. Date: Nov. 16, 2006

(54) Universal keyboard

(76) Inventor: Michel Artus, Quincampoix (FR)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/542,482

(22) PCT Filed: Jan. 16, 2004
(86) PCT No.: PCT/FR04/00095

§ 371 Date: May 5, 2006

(30) Foreign Application Priority Data
Jan. 16, 2003 (FR) 03/00443

(51) Int. Cl. B41J 5/00

(52) U.S. Cl. 400/486

(57) ABSTRACT

The keyboard for computer comprises a plurality of keys arranged in two groups, one for the left hand and one for the right hand.

According to the invention, each of the groups, for the four fingers except the thumb, comprises a basic key (B1 B2 B3 B4, B7 B8 B9 B10) and two adjacent keys (AE1 . . . , AI1 . . . ) aligned either side thereof, and for the thumbs a basic key (B5, B6), all said basic and adjacent keys together representing the 26 letters of the alphabet.

The invention pertains to a keyboard having a plurality of keys which are acted upon by pressure, keystroking or finger movement to command an action or to perform a selection of predefined characters or symbols.

Keyboards are commonly used to enter data that is to be processed by a system such as a computer system.

The subject of the invention is an ergonomic keyboard provided with a determined number of keys and whose layout enables quick learning.

This objective is achieved with a keyboard having a plurality of keys arranged in two groups, one for the left hand and one for the right hand, characterized by the fact that each of the groups, for the four fingers except the thumb, comprises a basic key and two adjacent keys aligned either side thereof, and for the thumbs a basic key, the said basic and adjacent keys representing the 26 letters of the alphabet.

According to a further characteristic, at least part of the basic keys represent the letters the most frequently used in Latin languages. In particular the keys of one hand represent the five vowels, and the basic keys of the other hand except the thumb represent four consonants from among: <<N, R, T, S, L, D>>.

According to a preferred embodiment, the basic keys and the respective adjacent keys for the fingers except the thumb are aligned perpendicular to the direction formed by the two groups of keys. In particular, the basic keys of the middle finger and ring finger are positioned forwardly with respect to the corresponding keys of the index finger and little finger.

According to another characteristic, the keyboard comprises ancillary keys for the index finger and little finger arranged in a line parallel to the line formed by the basic key and the respective adjacent keys. It also comprises ancillary keys either side of the basic key for each of the thumbs.

According to a particular embodiment, the keyboard comprises at least one group of additional keys, such as numeric, functional or arrow keys.

Preferably the keys are of incurved shape, the edges of the keys located on the periphery of said groups being raised.

According to another characteristic, the characters or symbols are assigned to the keys in tiers, the user passing from one tier to another by acting on a predefined key. In particular, since the keyboard comprises several tiers of characters corresponding to different Latin languages, the basic keys and the adjacent keys are assigned to characters common to said languages. In particular, characters particular to a language are allotted to the ancillary keys.

To further facilitate learning, characters forming mnemonic links with the characters of the basic keys are assigned to the adjacent keys.

According to a further characteristic, assignment of figures to the numeric tier is determined by the user. In particular, a figure is assigned per key in relation to the figure assigned to each of the fingers by automatic reflex.

The invention is described in more detail in the following description of one embodiment referring to the appended drawings in which:

FIG. 1 shows the layout of the keys in a keyboard of the invention,

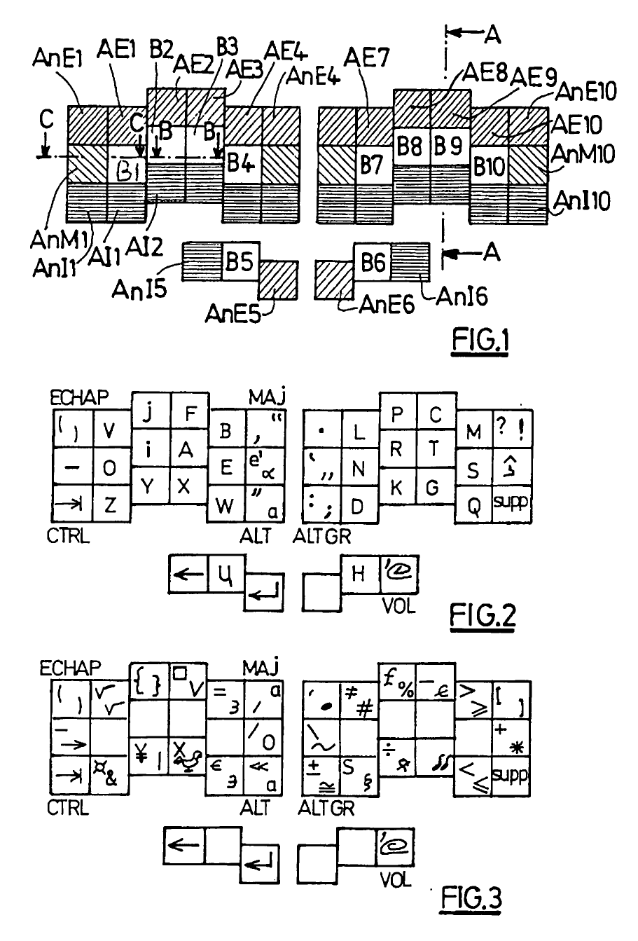

FIGS. 2 to 4 show three different tiers of characters associated with the keyboard,

FIG. 5 shows the profile of the keys along sections AA BB and CC in FIG. 1,

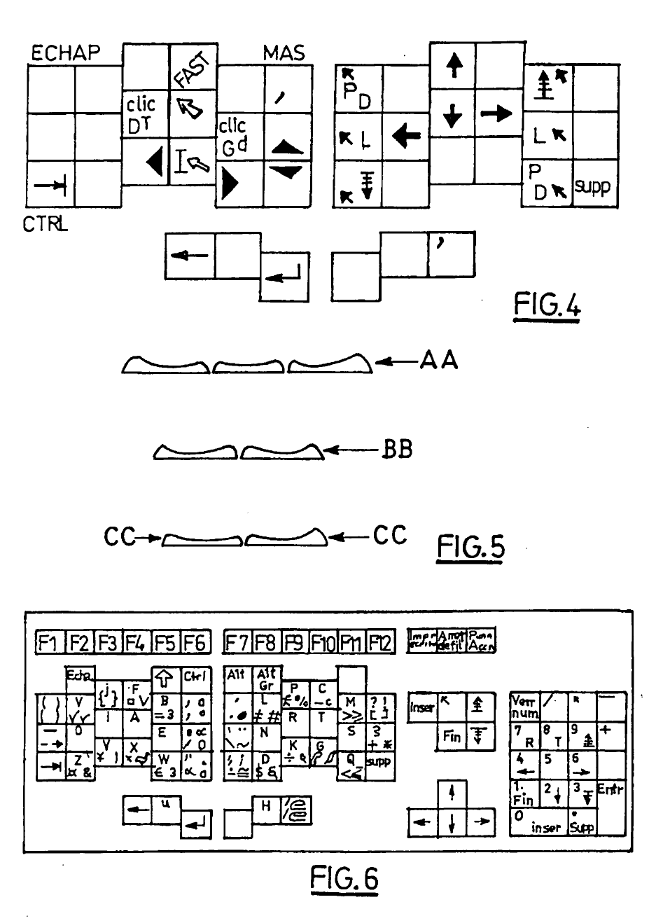

FIG. 6 shows a variant of the keyboard,

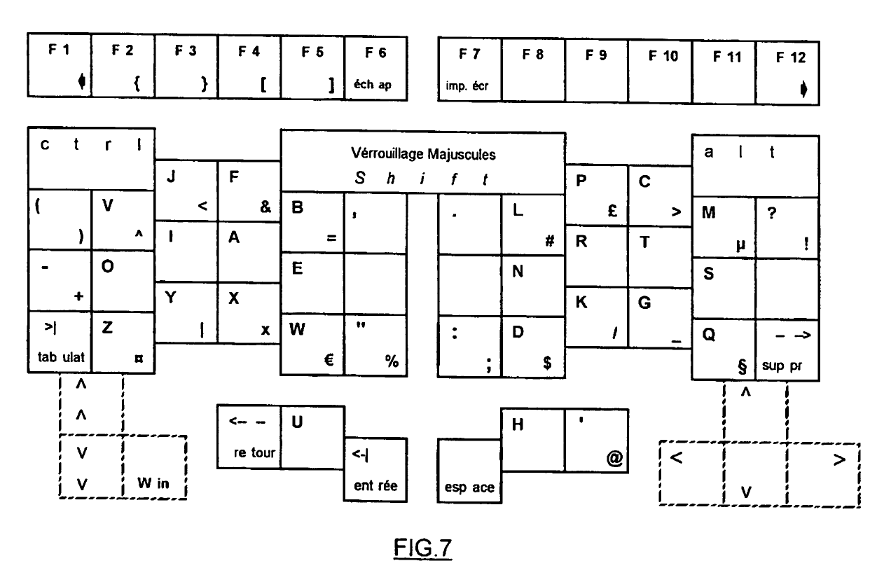

FIG. 7 shows another variant of the keyboard.

In the description given below reference is firstly made to an international form of keyboard, for languages using the Latin alphabet, comprising 42 keys. In another form, it may comprise 89 or an intermediate number.

In its basic form such as shown FIG. 1, the keyboard comprises 42 keys. The upper surfaces of the keys are globally positioned in one same plane. It is considered that the keyboard is in a suitable position for user comfort when it lies:
below the fingertip pads of the index, middle, ring, annular fingers, and the palm side of the last phalanx of the thumb when the hand is in rest position in equilibrium over a horizontal plane with fingers semi-flexed;
below the palm side of the hypothenar;
at finger crossover distance under the palm side of the wrist;
below the elbow.

This gives a globally horizontal position when the user is seated at a desk.

The keyboard comprises removable wedges, not shown, intended to raise the front edge if it is lower than the under surface of the user's elbows. It also comprises wedges intended to raise the rear edge for use when standing, as in pharmacies for example. With keyboards of narrow thickness the under surfaces of the hypothenar rest on the work surface (or on the posterior part of a laptop) provided the seat is adjusted so that the under surface of the elbows is level with the upper surface of the work surface. A rest must be provided if the keyboard is thick.

The upper surfaces of the eight outer and inner ancillary keys are raised by approximately one millimetre. The keyboard has several categories of keys: basic keys, adjacent keys and ancillary keys.

There are ten basic keys B1 to B10. They are positioned under each of the ten fingers when lightly touched by the hands in rest position, over a horizontal plane with fingers semi-flexed.

According to an important characteristic of the invention, the ten basic keys essentially represent the letters that are among those most frequently used in Latin languages. For example it is provided to assign the five vowels <<A, E, I, O, U>> to the five basic keys B1 to B5 of one hand and four letters from among <<N,R,S,T,L,D>> to the four basic keys B7 to B10 corresponding to the four fingers except the thumb of the other hand.

Keys B2, B3 and B8, B9 located under the ring fingers and middle fingers are positioned on a parallel to the user's right-left axis, slightly in front of the keys of little fingers B1, B10 and index fingers B4, B7 which are also on a parallel.

Advantageously, the offset is half the centre-to-centre distance, i.e. 9 mm for an adult keyboard.

According to the preferred embodiment shown FIG. 1, the thumb key B5, respectively B6 is positioned on a perpendicular to the user's right-left axis passing through the index finger key B4 and B7 respectively. The group of basic keys of the left hand and of the right hand are separated by a distance of two and half keys i.e. 45 mm in this case. The groups are symmetrical to one another with respect to a perpendicular to the user's right-left axis.

For the four fingers other than the thumb, there are two adjacent keys AE1 AE2 etc. and AI1, AI2 etc. per finger. They are positioned in an alignment either side of each basic key. A key AE is positioned forwardly, a so-called outer key with respect to the palm, the other key A1 positioned backwardly being a so-called inner key with respect to the palm. The axis passing through the centre of the three keys assigned to one same finger, other than the thumb, is perpendicular to the user's right-left axis. When the hands are placed in front of the body on a horizontal plane and the fingers are flexed and extended being allowed to slide over this plane, the pathways described by the fingertips are practically straight and perpendicular to the user's right-left axis. In this configuration, each finger except the thumb is assigned to a basic key and to two adjacent keys.

The adjacent keys represent the other letters of the Latin alphabet. Their assignment is detailed below in relation to mnemonics.

We therefore have twenty-six main keys, one for each letter of the alphabet.

The keyboard also comprises ancillary keys since twenty-six keys are insufficient to form a complete keyboard.

The thumbs comprise two ancillary keys, for the left thumb AnE5 and AnI5 positioned:
right key AnE5, so-called outer key with respect to the palm, adjacent but offset towards the user by half the centre-to-centre distance. In the illustrated example it is 9 mm;
left key AnI5, so-called inner key with respect to the palm, on the same line parallel to the user's right-left axis. Typing is easier in extension, i.e. from the basic key towards the outer adjacent key rather than towards the inner adjacent key. For the right thumb, keys AnE6 and AnI6 are provided which are defined similarly. In the example under consideration, key AnE6 is the spacer key and key AnE5 is the Enter key.

On account of the mobility of the index fingers and little fingers, the keyboard comprises twelve ancillary keys related thereto. These are ancillary keys: outer keys AnE1, AnE4, AnE7 and AnE10, median keys AnM1 AnM4 AnM7 and AnM10, and inner keys AnI1 AnI4 AnI7 and AnI10. They essentially contain accessory signs that are infrequently used.

According to a preferred embodiment, a separation is arranged between the keys of the two hands. For example, this separation may extend over half the centre-to-centre distance between the ancillary keys of the index fingers and the outer adjacent keys of the thumbs, i.e. 9 mm in the case under consideration. The general plan is given FIG. 4.

Advantageously, the sensitivity of the keys, in particular those which are in ancillary and adjacent position, is fairly high. The sensitivity of the basic keys is determined so as to enable the fingers to be placed thereupon, at rest, without triggering any contact.

Advantageously the keys have a morphology enabling easy contact.

For example, the upper surface of each key is hollow in the centre and raised around its periphery. In this manner, the finger can perceive its position with respect to the keyboard, and the finger height between two keys pressed by the same finger remains the same. For example, the raising of the edges may progressively reach 3 mm with respect to the centre of the key.

To separate the keys, a space of one millimetre is left between them. The upper external edge slopes down abruptly to level zero.

The ten basic keys B1 to B10, positioned under the fingers at rest, preferably have a different colour and texture to the other keys so that they can be recognized as different both visually and by the fingers.

According to a preferred embodiment, each key gives a different signal depending upon the manner in which it is activated.
A single click, when the key is pressed down then rapidly released, activates the main function assigned to the key in a given tier.
A double click when the key is pressed down, released, and pressed again, similar to the known mouse double-click, activates the second function allocated to a key in a given tier. In the bottom tier, however, for the basic keys and adjacent keys, the double-click activates repetition of the single click. Therefore in the tier of lowercase letters of the mother language a double-click on a letter types it twice.
Holding down a key which remains pressed during the entire action time, similar to the “Caps” or “Ctrl” keys in conventional keyboards. This makes it possible to type other functions during this holding down.
Press-release when the key is pressed down a certain time before being released. This enables the changeover from one tier to another for example.

The two last types of key pressing do not co-exist on one same key in one same tier. Certain types of contact do not produce any effect with some keys of a given tier.

According to an important characteristic of the invention and one embodiment, the keyboard comprises several tiers which can be accessed for example by press-release on one of the twenty-six alphabetic keys. A tier is defined as the set of key assignments for the same assignment of the tier changeover key. At a given tier, a certain number of functions are activated when typing the keys. On tier changeover, the assignment of the keys changes. This arrangement enables simple mnemonic association of: “tier plus key equals function”.

For example, eight tiers are defined AAA to HHH, accessed by press-release of the key marked with the corresponding letter.

Then typing of the key marked d/D for example, depending upon the tier, gives the following values:
d, at tier AAA, grouping together the lowercase characters of the first language which is the mother language;
D, at tier BBB, grouping together the uppercase characters of the mother language;
$ (dollar), at tier CCC, grouping together the figures and signs, with a single click;
§ (of similar graphics to $), at tier CCC, with a double click;
d, at tier LLL, grouping together the lowercase characters of the second language;
D, at tier MMM, grouping together the uppercase characters of the second language;
d, at tier NNN, third language in lowercase;
D, at tier OOO, third language in uppercase;
δ at tier GGG, Greek lowercase;
Δ at tier HHH Greek uppercase;
a special tier DDD, comprises the arrow keys as shown FIG. 4.

With this method it is possible to create as many tiers as there are keys.

With this arrangement, learning is particularly fast.

In most individuals each finger is connected with a numerical symbol. According to globe regions and different peoples, the symbolic projection is different. Thumb=1, index finger=2 etc. for most Latin peoples. Index finger or little finger=1, thumb=5 for some Anglo Saxons. In addition, some persons begin with the right hand, others with the left hand. Due heed is given to this pre-existing automatic reflex. Each user can enter his/her own code onto each of the ten basic keys (0 for 10) at tier CCC of signs and figures.

For 80% of Latin people this gives: right thumb=1, right index finger=2, right middle finger=3, right ring finger=4, right little finger=5, left thumb=6, left index finger=7, left middle finger=8, left ring finger=9, left little finger=0; for other persons the distribution is different.

The learning method uses this cerebral-dactyl reflex to create another automatic reflex connecting each finger with the letter of its basic key. This is essential for the eight fingers other than the thumbs since they must each type two other adjacent letters. To firmly entrench this automatic reflex, a connection is also created between each homologous finger (Right index finger—Left index finger, Right middle finger—Left middle finger, etc.).

The letters forming this homologous connection, in this case, are NE RA TI SO or HU NE RA TI SO to be spelt or read according to language. During this phase it is learnt to type frequent sequences of the language by automatic reflex, for example in French: ent, ses, ont, son, sen, oi, ai, tr, etc.

Once the cerebral-dactyl reflex has been definitely learnt for the eight essential basic letters, learning mnemonics are used linking together the three letters of one same finger.

This second learning phase begins with the left hand.

A first element is the position W, X, Y, Z in index finger to little finger order on the inner adjacent keys. This makes them easy to memorize. The second element concerns the mnemonics connecting together the three letters.

VOZ, which in Spanish means “voice”, O and Z already being previously memorized.

*JIY These three letters are connected. “j” and “i” are dotted and “y” is pronounced “i” in numerous languages including English.

FAX is known worldwide, as is WEB which here must be read from bottom upwards, but the series WXYZ is easily identified with the inner adjacent keys.

For the right hand, the vowel of the homologous finger of the other hand is used. This gives words that are mostly known or learnt as such.

LEND corresponds in order to the outer adjacent, then the basic vowel, then the basic consonant, then the inner adjacent.

PARK identical order to above: in addition P, R, and K have similar graphics. CITY G the order is identical but Y (also with ring finger) is inserted in between. In English G is a music note (do) and rhymes with i. C and G also have similar graphics.

MOSQuito first three letters in order.

The other assignments comply with a logic whose explanation will facilitate learning.

Assignment to tiers of letters (AAA, BBB, LLL, MMM, NNN, OOO).

To ensure the universal nature of the keyboard, a character, a sign, a function or an order have user-independent definition.

Some tiers may be fully programmable, such as JJJ for “joystick”.

It is an international “Latin” keyboard, having English as common basis but respecting each of the other languages. It is intended to be a good keyboard for every language.

At the tiers of languages, including tiers AAA (mother language lowercase) and BBB (mother language uppercase) which are the reference steps and whose assignment is marked on the keyboard, the letters of the alphabet are always positioned at the same place irrespective of the language. They are typed with a single click. A double-click is used to duplicate them. They are shown FIG. 2.

The three accent keys.

These are positioned at the median ancillaries of the index fingers (right and left) and of the right little finger as can be seen FIG. 2. They are conventionally named a//E, à//N et à//S with reference to the basic key of which they are the median ancillary.

They comprise accents, additional signs and letters and are characteristic of the language used. Only these keys change when a tier is assigned to another language. The thirty-nine other keys are not changed which gives a universal character (Latin) to this keyboard. The accents are also present on the lowercase and uppercase tier of one same language. This makes it possible to have all accents available under the fingers when typing in uppercase.

Regarding accents, these are typed after the letter, in the way they are spelt in the language under consideration. For example in French, when designating È, it is spelt “E accent grave” and not “accent grave on E” which would not designate the character but the accent.

Insofar as is possible, when only one letter has an accent, it is placed in mnemonics with the same letter without an accent and is typed directly. For example É in French is typed with the same finger as the key e//E. This similarly applies to ñ and the n//N key in Spanish.

Due heed is also paid to the mnemonics from one language to another, so that a “multi-linguist” user is able to find the same accents at the same positions under the fingers. When the number of accents or additional letters is limited and blank keys remain, they are used for the signs of tier CCC (figures and signs). The entire key must be blank to make this assignment so as not to cause any confusion in automatic reflexes. Therefore for each language containing accents, the tier allocated to it is bilingual and makes it possible to type English without having to change tiers.

The ancillary keys of the thumbs and the ancillaries of the other fingers, as shown FIG. 2, enable elementary punctuation to be found under the fingers on the same tier. It is to be noted that the Enter key is positioned on an ancillary key of the left thumb.

FIG. 3 shows the tier of numbers and signs.

FIG. 4 shows the navigational tier with keys that can be enabled or disenabled by a single click or double-click. In pointer mode, it is the screen which is the reference surface. The pointer is able to move over its entire surface. In cursor mode, it is the text entry surface which is the reference surface. The cursor remains therein.

When the pointer key, with the arrow positioned under the middle finger, is released it is the cursor which is moved by the right hand. The mode is cursor mode.

When this key is pressed down for an extended time, it is the pointer which is moved. The mode is pointer mode.

In a simplified form the keyboard, as shown FIG. 6, comprises navigational and function keys and a numeric pad; in this case, it is possible to have only three levels: a basic level with mother language lowercase, the uppercase level being enabled by a single click for example on the Caps key, and a level for figures and signs.

In another simplified form shown FIG. 7, the keyboard comprises 64 keys distributed as follows:
61 so-called universal keys have an assignment which remains unchanged irrespective of the alphabetical language represented,
3 adjacent keys (here the adjacent keys next to keys E N and S) have an assignment which is related to the language of the keyboard. For example:
   for English the allocation is /\ [symbol] respectively,
   for Spanish the allocation is ´\tilde{N} [symbol] respectively,
   for French, the allocation is ˆ´É respectively, etc.

On the keyboard in FIG. 7, the character indicated at the top left of each key is obtained when it is typed normally. Advantageously the numeric sign, symbol or punctuation indicated on the bottom left of each key is obtained with so-called press-release typing as defined above.

For these latter signs, there are only 45 universal keys; 19 keys are not predefined. For example, the figures are arranged on the ten basic keys but their arrangement is dependent upon the manner in which it is counted on the fingers in the country concerned. The objective is to give the user an arrangement of figures under the fingers, placed over the basic keys, which corresponds to the user's own way of counting on the fingers. This makes learning easier.

Further advantageously for this keyboard, the basic keys have a different morphology to the other keys. These are recognized tactile fashion by mere contact of the fingers on the keys. For example provision may be made to form a slight hollow on the surface of the basic keys, and a flat for the other keys. The user will then be able to position the fingers properly over the basic keys before typing.

1. Keyboard for computer comprising a plurality of keys arranged in two groups, one for the left hand and one for the right hand, characterized by the fact that each of the groups, for the four fingers except the thumb, comprises a basic key (B1 B2 B3 B4, B7 B8 B9 B10) and two adjacent keys (AE1 . . . , AI1 . . . ) aligned either side thereof, and for the thumbs a basic key (B5, B6), all said basic and adjacent keys together representing the 26 letters of the alphabet.

2. Keyboard as in the preceding claim in which at least part of the basic keys (B1 . . . ) represent the most frequent letters in Latin languages.

3. Keyboard as in the preceding claim whose basic keys of one hand represent the five vowels, and the basic keys of the other hand except the thumb, represent four consonants from among <<N, R, T, S, L, D>>.

4. Keyboard as in any preceding claim, whose basic keys with their respective adjacent keys for the fingers except the thumb are aligned perpendicular to the direction formed by the two groups of keys.

5. Keyboard as in claim 1, comprising ancillary keys (AnE, AnM, AnI) for the index finger and little finger, arranged in a line parallel to the line formed by the basic key and the respective adjacent keys.

6. Keyboard as in claim 1, comprising ancillary keys (AnI5, AnE5, AnI6, AnE6) either side of the basic keys for the thumbs.

7. Keyboard as in any preceding claim, whose basic keys (B2 B3, B8 B9) of the middle finger and ring finger are positioned forwardly with respect to the corresponding keys of the index finger and little finger.

8. Keyboard as in any preceding claim, comprising at least one group of additional keys, such as numeric, functional or arrow keys.

9. Keyboard as in any preceding claim, whose basic keys have a different morphology to the other keys.

10. Keyboard as in any preceding claim, whose characters or symbols are assigned to the keys in tiers, and in which the changeover from one tier to another is made by acting on a key.

11. Keyboard as in claim 10, comprising several tiers of characters corresponding to different Latin languages, whose basic keys and adjacent keys are assigned to characters common to the said languages.

12. Keyboard as in the preceding claim, whose characters particular to a language are assigned to the ancillary keys.

13. Keyboard as in any preceding claim, in which characters forming mnemonic links with the characters of the basic keys are assigned to the adjacent keys.

14. Keyboard as in any of claims 8 to 12, whose assignment of figures to the numeric tier is determined by the user, for example in relation to the manner the user counts on the fingers.
